(19) United States
(12) Patent Application Publication
(10) Pub. No.: US 2004/0263391 A1
(43) Pub. Date: Dec. 30, 2004

(54) Multi-band antenna

(76) Inventors: Zi-Ming He, Irvine, CA (US); Ping Peng, Irvine, CA (US); David(Tso-Chin) Ko, Fullerton, CA (US); Yin Qian, Hacienda Heights, CA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/607,778

(22) Filed: Jun. 27, 2003

(51) Int. Cl. H01Q 1/38

(52) U.S. Cl. 343/700 MS

(57) ABSTRACT

A multi-band antenna includes an insulative substrate (1) carrying a conductive element (2) and a coaxial cable (3). The conductive element includes a first radiating patch (22) resonating at a first frequency band and a second radiating patch (23) resonating at a second frequency band. The first radiating patch is spaced from the second radiating patch by a non-conductive gap (21). The coaxial cable comprises an inner conductor (31) and an outer conductor (32). The inner conductor electrically connects with the first radiating patch. The outer conductor electrically connects with the second radiating patch. The first and the second radiating patches function as grounding means for each other. The multi-band antenna, therefore, has a simple, structure while maintains a wide-bandwidth characteristic.

### BACKGROUND OF THE INVENTION

1. Field of the Invention

The present invention relates to an antenna, and in particular to an antenna which is capable of operating in multiple frequency bands.

2. Description of the Prior Art

In recent years, planar inverted-F antennas (PIFA) have become increasingly popular. A paper titled “Dual-Frequency PIFA”, Microstrip Antenna Design Handbook by Ramesh Garg et al, 2001, Section 10.9.3, pp. 646-653 discloses a conventional antenna shown in FIG. 10.45 thereof. The conventional antenna comprises two separate radiating elements spaced to each other by an L-shaped gap. Each radiating element has a feed pin and a ground pin of its own, thereby forming an independent PIFA. The radiating elements constitute independent regions having different resonant frequencies. However, because each radiating element must have a feed pin and a ground pin of its own, the conventional antenna has a complicated structure.

Hence, an improved antenna is desired to overcome the above-mentioned shortcomings of existing antennas.

### BRIEF SUMMARY OF THE INVENTION

A main object of the present invention is to provide a multi-band antenna having a simple structure while maintaining a wide-bandwidth characteristic.

A multi-band antenna in accordance with the present invention comprises an insulative substrate carrying a conductive element and a coaxial cable. The conductive element comprises a first radiating patch and a second radiating patch. The first radiating patch is spaced from the second radiating patch by a non-conductive gap. The coaxial cable comprises an inner conductor and an outer conductor. The inner conductor electrically connects with the first radiating patch. The outer conductor electrically connects with the second radiating patch. When the multi-band antenna is fed first frequency band signals, the first radiating patch resonates at the first frequency band signals and capacitively couples to the second radiating patch. The second radiating patch functions as a grounding means for the first radiating patch. When the multi-band antenna is fed second frequency band signals, the second radiating patch resonates at the second frequency band and capacitively couples to the first radiating patch. The first radiating patch functions as a grounding means for the second radiating patch.

In the present invention, the first and the second radiating patches resonate respectively at different frequency bands and function as grounding means for each other. The single feed line feeds signals for both of the first and the second radiating patches. The multi-band antenna, therefore, has a simple structure while maintains its wide-bandwidth characteristic.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a top view of a multi-band antenna in accordance with the present invention;

FIG. 2 is a side view of the multi-band antenna of FIG. 1 with a feed line thereof removed;

FIG. 3 is a perspective view of an electrical device, showing locations of a pair of multi-band antennas of FIG. 1 mounted therein;

FIG. 4 is a test chart recording for the multi-band antenna of FIG. 1, showing Voltage Standing Wave Ratio (VSWR) as a function of frequency;

FIG. 5 is a horizontally polarized principle plane radiation pattern (where the principle plane is an X-Y plane) of the multi-band antenna of FIG. 1 operating at a frequency of 2.49 GHz;

FIG. 6 is a vertically polarized principle plane radiation pattern (where the principle plane is an X-Y plane) of the multi-band antenna of FIG. 1 operating at a frequency of 2.49 GHz;

FIG. 7 is a horizontally polarized principle plane radiation pattern (where the principle plane is an X-Y plane) of the multi-band antenna of FIG. 1 operating at a frequency of 5.35 GHz;

FIG. 8 is a vertically polarized principle plane radiation pattern (where the principle plane is an X-Y plane) of the multi-band antenna of FIG. 1 operating at a frequency of 5.35 GHz;

FIG. 9 is a horizontally polarized principle plane radiation pattern (where the principle plane is an X-Y plane) of the multi-band antenna of FIG. 1 operating at a frequency of 5.9 GHz; and

FIG. 10 is a vertically polarized principle plane radiation pattern (where the principle plane is an X-Y plane) of the multi-band antenna of FIG. 1 operating at a frequency of 5.9 GHZ.

### DETAILED DESCRIPTION OF THE INVENTION

Reference will now be made in detail to a preferred embodiment of the present invention.

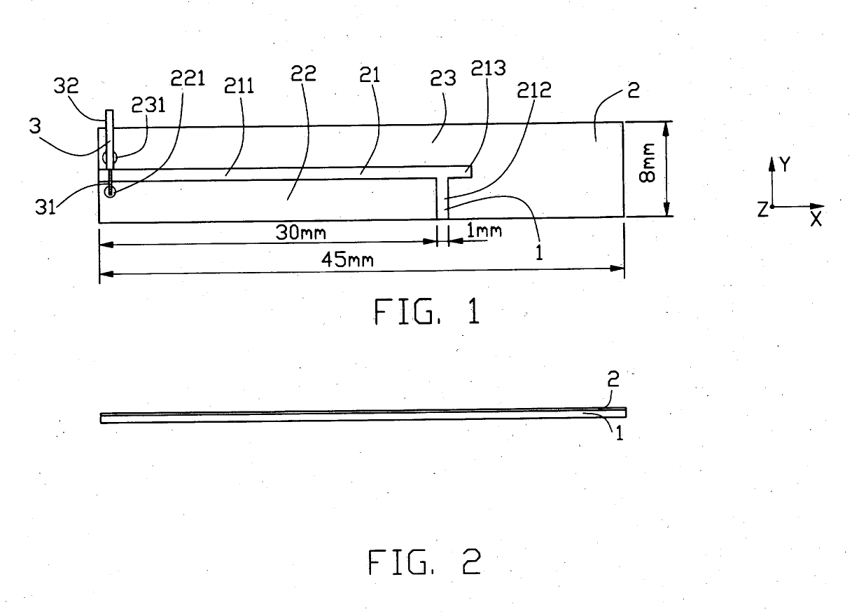

Referring to FIGS. 1 and 2, a multi-band antenna in accordance with a preferred embodiment of the present invention comprises an insulative substrate 1, a conductive element 2 carried by the insulative substrate 1 and a feed line 3 electrically connecting with the conductive element 2.

The insulative substrate 1 is substantially rectangular and comprises a planar major surface (not labeled) carrying the conductive element 2. The conductive element 2 has a substantially rectangular configuration confined by a substantially continuous border line. A non-conductive gap 21 divides the conductive element 2 into a first radiating patch 22 resonating at a higher frequency band and a second radiating patch 23 resonating at a lower frequency band. The non-conductive gap 21 has a substantially T-like configuration and comprises a horizontal first branch 211, a perpendicular second branch 212 and a horizontal third branch 213. The first branch 211 comprises an outer end (not labeled) arranged on a left edge of the conductive element 2. The third branch 213 extends into the second radiating patch 23 from a junction of the first and the second braches 211 and 212. The first radiating patch 22 is rectangular and is parallelly spaced from the second radiating patch 23 by the first and the second branches 211 and 212. The second radiating patch 23 has a substantially inverted J-like configuration and surrounds two sides of the first radiating patch 22. The first radiating patch 22 comprises a first excitation point 221 thereon. The second radiating patch 23 comprises a second excitation point 231 thereon. The first and the second excitation points 221 and 231 are adjacent to the outer end of the first branch 211 of the non-conductive gap 21.

The feed line 3, in this preferred embodiment, is a coaxial cable comprising an inner conductor 31, an inner insulator (not shown) surrounding the inner conductor 31 and an outer conductor 32 surrounding the inner insulator. The inner conductor 31 is soldered to the first excitation point 221 of the first radiating patch 22. The outer conductor 32 is soldered to the second excitation point 231 of the second radiating patch 23.

In present invention, by adjusting the lengths of the first and the second radiating patches 22 and 23, operating frequencies of the multi-band antenna can be changed. By adjusting the width and length of the non-conductive gap 21, the bandwidth of the multi-band antenna can be adjusted. By adjusting the distance of the excitation points 221 and 231 from the left edge of the conductive element 2, the impedance matching and Voltage Standing Wave Ratio (VSWR) can be improved. Detailed dimensions of the preferred embodiment of the multi-band antenna are shown in FIG. 1. The dimensions are in millimeters and are such that the multi-band antenna is configured to resonate within the two frequency bands. When the multi-band antenna is fed the higher frequency band signals between 4.9 Gfz and 5.9 GHz (i.e., the 5 GHz frequency band), the first radiating patch 22 resonates at the higher frequency band signals and capacitivly couples to the second radiating patch 23 via the first and the second branches 211, 212. The second radiating patch 23 functions as a grounding plane for the first radiating patch 22. The first radiating patch 22, therefore, is configured and sized to function as a first planar inverted-F antenna (PJFA). When the multi-band antenna is fed the lower frequency band signals between 2.39 GHz and 2.49 GHz (i.e., the 2.45 GHz frequency band), the second radiating patch 23 resonates at the lower frequency band signals and capacitively couples to the first radiating patch 22. The first radiating patch 22 functions as a grounding plane for the second radiating patch 23. The second radiating patch 23, therefore, is configured and sized to function as a second PIFA.

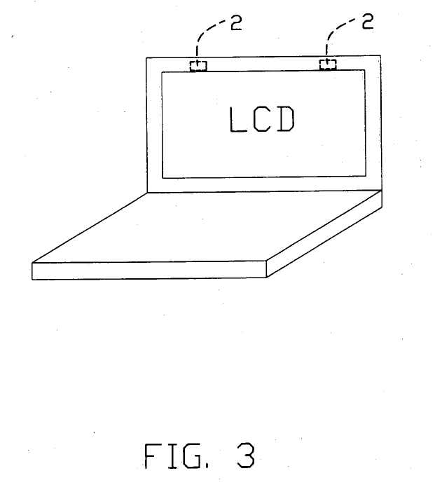

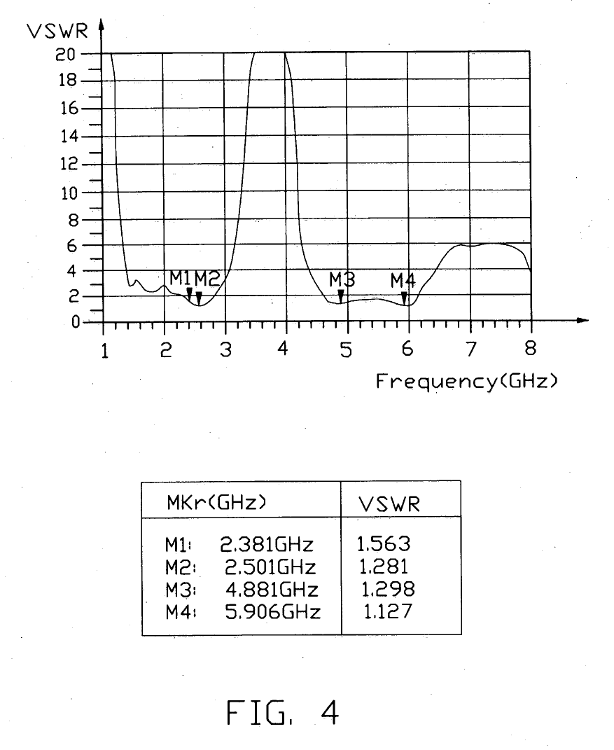

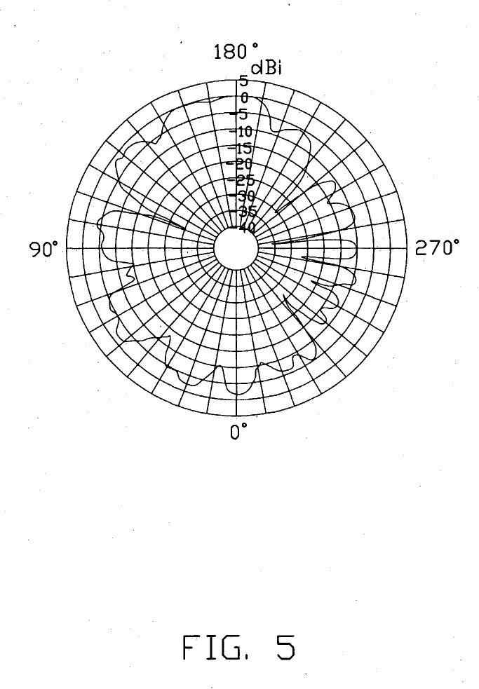

The antenna performance was measured in Anechoic Chamber. The multi-band antenna was located inside the electrical device, a notebook panel in this embodiment, during measurement. FIG. 3 shows a pair of the multi-band antennas is symmetrically mounted in chambers above a Liquid Crystal Display (LCD) of the notebook. FIG. 4 shows a test chart recording of VSWR of the multi-band antenna as a function of frequency. The antenna operation bandwidth is usually defined by VSWR≦.0. Note that VSWR drops below the desirable maximum value “2” in the 2.45 GEz frequency band and in the 5 GHz frequency band, i.e., the operation bandwidth of the multi-band antenna covers 2.39-2.49 GHz and 4.9-5.9 GHz, indicating acceptably efficient operation in these two frequency bands and a wide bandwidth in the 5 GHz frequency band.

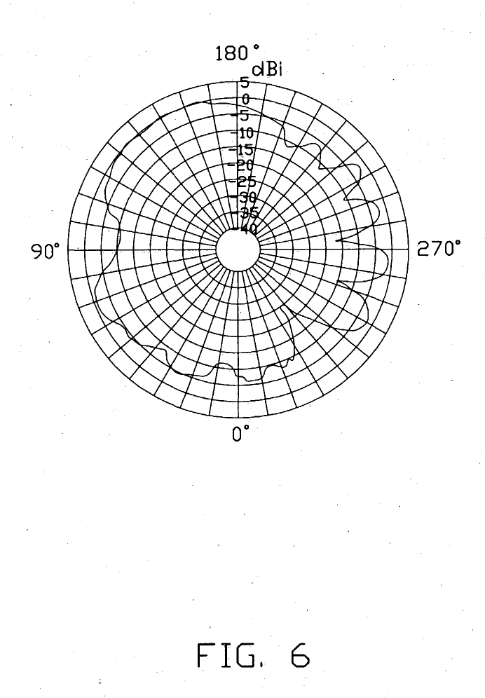

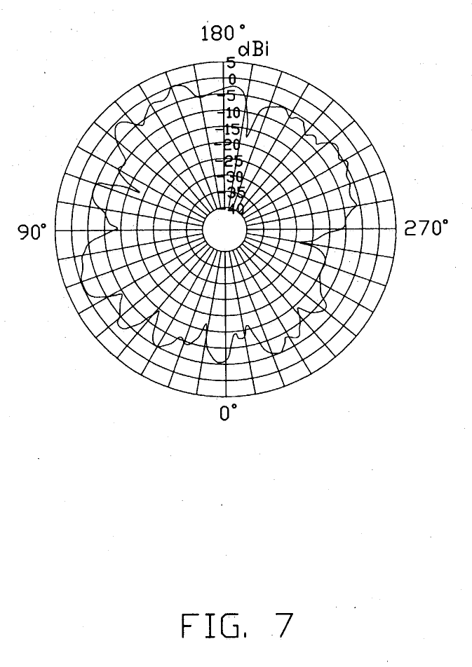

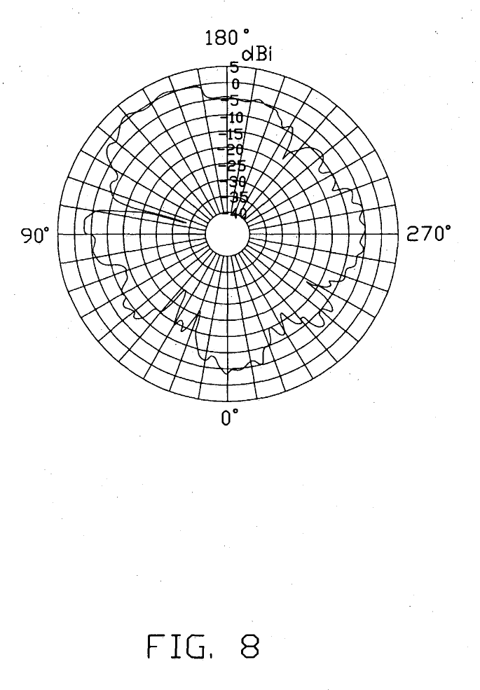

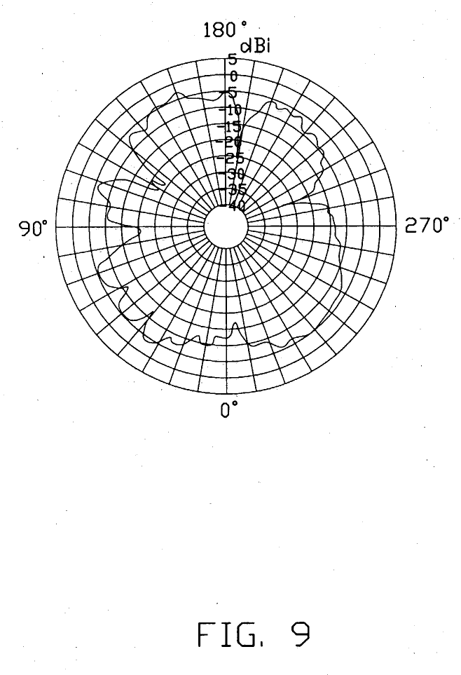

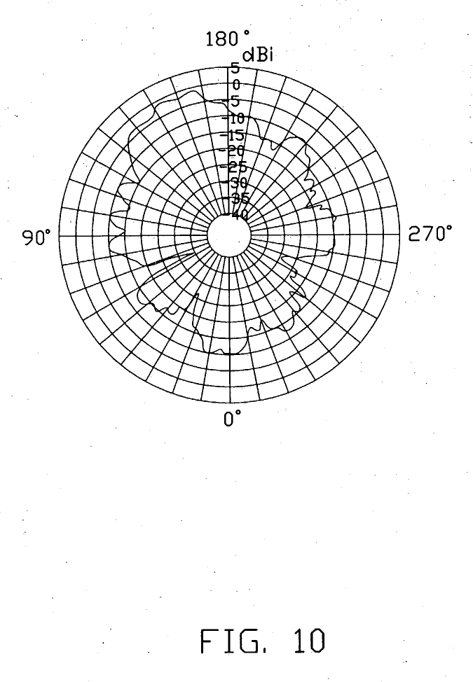

FIGS. 5-10 respectively show horizontally and vertically polarized principle plane radiation patterns of the multi-band antenna operating at frequencies of 2.49 GHz, 5.35 GHz and 5.9 GHz (the principle plane is the X-Y plane shown in FIG. 1). Note that each radiation pattern is close to a corresponding optimal radiation pattern.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1: A multi-band antenna comprising:
an insulative substrate comprising a major surface;
a conductive element formed on the major surface of the insulative substrate, the conductive element comprising a first part resonating at a first frequency band and a second part resonating at a second frequency band, the first part and the second part being disconnected with each other by a non-conductive gap; and
a coaxial cable comprising an inner conductor and an outer conductor, the inner conductor electrically connecting with the first part of the conductive element and the outer conductor electrically connecting with the second part of the conductive element.

2: The multi-band antenna as claimed in claim 1, wherein the non-conductive gap comprises a first branch and a second branch substantially perpendicular to the first branch, the first and the second branches separating the first part from the second part.

3: The multi-band antenna as claimed in claim 2, wherein the first branch comprises an open end arranged on a border line of the conductive element, and electrical connections between the coaxial cable and the conductive element are adjacent to the open end of the first branch.

4: The multi-band antenna as claimed in claim 2, wherein the non-conductive gap comprises a third branch extending from a junction of the first and the second branches into the second part of the conductive element

5: The multi-band antenna as claimed in claim 1 wherein the first part is substantially rectangular and the second part surrounds two sides of the first part.

6: A multi-band antenna comprising:
a first conductive patch operating at a first frequency band;
a second conductive patch operating at a second frequency band, the second conductive patch substantially partially surrounding the first conductive patch; and
a feed line comprising a first portion and a second portion, the first portion electrically connecting the first conductive patch, the second portion electrically connecting the second conductive patch;
wherein when the first conductive patch operates in the first frequency band, the second conductive patch functions as a grounding portion for the first conductive patch; and when the second conductive patch operates in the second frequency band, the first conductive patch functions as a grounding portion for the second conductive patch.

7: The multi-band antenna as claimed in claim 6, wherein the feed line is a coaxial cable and comprises an inner conductor electrically connecting the first conductive patch and an outer conductor electrically connecting the second conductive patch.

8: The multi-band antenna as claimed in claim 6, wherein the first conductive patch is spaced from the second conductive patch by a non-conductive gap.

9: The multi-band antenna as claimed in claim 8, wherein the non-conductive gap comprises a first branch and a second branch substantially perpendicular to the first branch, the first and the second branches separating the first conductive patch from the second conductive patch.

10: The multi-band antenna as claimed in claim 9, wherein the first branch comprises an open end arranged on a border line of the multi-band antenna, electrical connections between the coaxial cable and the multi-band antenna are adjacent to the open end of the first branch.

11: The multi-band antenna as claimed in claim 9, wherein the non-conductive gap comprises a third branch extending from a junction of the first and the second branches into the second conductive patch.

12: The multi-band antenna as claimed in claim 8, wherein the first and the second conductive patches capacitively couple to each other via the non-conductive gap.

13: The multi-band antenna as claimed in claim 6, comprising an insulative substrate, the insulative substrate forming a major surface carrying the first and the second conductive patches.

14: A multi-band antenna comprising:
a rectangular insulative substrate defining a lengthwise edge and a lateral edge;
a conductive element formed on the substrate and have thereof an overall dimension similar to said substrate, said conductive element including a small first radiating patch and a large radiating patch separated from each other by a generally L-shaped gap, said gap being equipped with thereof two opposite ends terminating at said lengthwise edge and said lateral edge, respectively; and
a coaxial cable including an inner conductor and an outer conductor respectively connected to the first radiating patch and the second radiating patch around said lateral edge.

15: the multi-band antenna as claimed in claim 14, wherein said generally L-shaped gap includes a long section parallel to said lengthwise edge and a short section parallel to said lateral edge.

16: The multi-band antenna as claimed in claim 15, wherein said generally L-shaped gap further includes another short section extending from a joint section of said long section and said short section and opposite to said long section.
